(19) United States
(12) Patent Application Publication
(10) Pub. No.: US 2006/0031639 A1
(43) Pub. Date: Feb. 9, 2006

(54) Write unmodified data to controller read cache

(75) Inventor: Michael T. Benhase, Tucson, AZ (US)

Correspondence Address: SCULLY, SCOTT, MURPHY, & PRESSER, 400 GARDEN CITY PL, GARDEN CITY, NY, 11530, US

(73) Assignee: International Business Machines Corporation, Armonk, NY (US)

(21) Appl. No.: 10/912,847

(22) Filed: Aug. 6, 2004

(51) Int. Cl. G06F 12/00

(52) U.S. Cl. 711/122; 711/133; 711/144; 711/113

(57) ABSTRACT

Disclosed are a method and apparatus, in a data storage environment with multiple devices sharing data, for writing data to one such device in a manner that indicates that the data need not be destaged to a lower tier of the storage hierarchy. As a specific example, a host computer system may issue a write command to a controller that signals the controller that it is not necessary to destage the data from the controller cache because the data has not been modified by the host. In a preferred embodiment, the controller's cache is an extension of the host's cache, rather than a duplication. To achieve this, the controller needs to know: 1) what data, being requested by the host, is being cached by the host, and should not be cached by the controller, and 2) what data has been cast out of the host's cache, and should now be cached by the controller.

### BACKGROUND OF THE INVENTION

1. Field of the Invention

This invention generally relates to hierarchical caching of data, and more specifically, to caching data in a data storage environment having a hierarchy of data caches. Even more specifically, in a preferred implementation, the invention relates to caching data in a multiprocessing system in which a storage controller interfaces between multiple host computer systems and a direct access storage device system.

2. Background Art

A modern shared-storage multiprocessing system may include a plurality of host processors coupled through several cache buffer levels to a hierarchical data store that includes a random access memory level followed by one or more larger, slower storage levels such as Direct Access Storage Device (DASD) and tape library subsystems. Transfer of data up and down such a multilevel shared-storage hierarchy requires data transfer controllers at each level to optimize overall transfer efficiency.

In typical disk caching environments, the host uses some of its RAM (FIG. 3 #74 memory) as a cache for disk storage. The host disk cache is faster to access than disk, but is more expensive per byte, and therefore has less capacity than disk. The host disk cache may hold both CPU instructions (typically not modified by the CPU) and data structures (which are sometime, but not always modified by the CPU). If the host needs access to instructions or data which are not resident in the host disk cache, the host issues a read I/O request to the disk controller. The disk controller services the host read I/O request from the disk controllers cache (if the data is resident there) or issues a read I/O request (stage) to the disk.

The host CPU may optionally modify the data in host disk cache.

Periodically, data must be removed from the host disk cache (and/or controller cache) to make room for other data. If the data to be removed is modified, the host must issue a write I/O request to the disk controller to assure the modifications to the data are written to disk. The disk controller must issue a write I/O request (destage) to the disk before the data is removed from the controller's cache to make room for other data.

If the data to be removed from cache is unmodified, today the host just reuses the space for other data. This can result in the same data being cached in both the host computer cache and the controller cache, resulting in a waste of cache space.

### SUMMARY OF THE INVENTION

An object of this invention is to improve procedures for caching data in a hierarchical caching environment.

Another object of the invention is to minimize the duplication of data in both the host and disk controller's cache, and to minimize the need to restage data from disk.

A further object of the present invention is, in a large distributed computer system, in which a storage controller interfaces between multiple host computer systems and a direct access storage device system, to use the controller's cache as an extension, rather than a duplication, of the host's cache.

These and other objectives are attained with a method and apparatus, in a data storage environment with multiple devices sharing data, for writing data to one such device in a manner that indicates that the data need not be destaged to a lower tier of the storage hierarchy. By way of a specific example, a host computer system may issue a write command to a controller that signals the controller that it is not necessary to destage the data from the controller cache because the data has not been modified by the host.

In the preferred embodiment of the invention, described in detail below, the controller's cache is an extension of the host's cache, rather than a duplication. To achieve this, the controller needs to know:
1. what data, being requested by the host, is being cached by the host, and should not be cached by the controller, and
2. what data has been cast out of the host's cache, and should now be cached by the controller.

To accomplish this, the preferred embodiment of the invention provides a new write command (from host to controller) which is issued when data is cast out of the host's cache. With the invention, if the data to be removed is unmodified, the host may issue the new write I/O request to the disk controller (1) passing the data being removed from the host disk cache, to the controllers cache, and (2) indicating the data is unmodified and need not be updated on disk. The disk controller need not issue a write I/O request (destage) to the disk when the data is removed from the controller's cache to make room for other data. The command (without the data transfer) could optionally be used to request a prestage of the data by the controller.

Further benefits and advantages of the invention will become apparent from a consideration of the following detailed description, given with reference to the accompanying drawings, which specify and show preferred embodiments of the invention

### BRIEF DESCRIPTION OF THE DRAWINGS

FIG. 1 is a block diagram illustrating a software and hardware environment in which preferred embodiments of the invention may be implemented.

FIG. 2 is a functional block diagram of the storage controller of the environment of FIG. 1.

FIG. 3 is a block diagram of a computer system that may be used in the environment of FIG. 1.

FIGS. 4 and 5 are flow charts illustrating the operation of two write commands that may be issued in the practice of this invention.

### DETAILED DESCRIPTION OF THE PREFERRED EMBODIMENTS

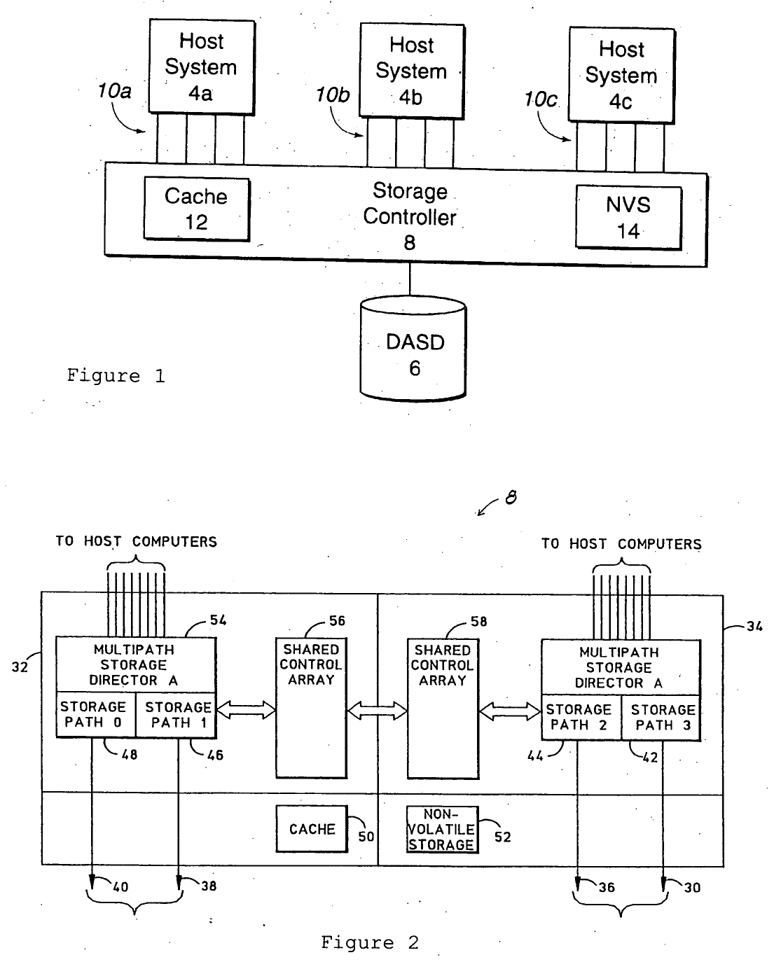

FIG. 1 illustrates a hardware environment in which preferred embodiments may be implemented. A plurality of host systems 4a, b, c are in data communication with a DASD 6 via a storage controller 8. The host systems 4a, b, c may be any host systems known in the art, such as a mainframe computer, workstations, etc. A plurality of channel paths 10a, b, c in the host systems 4 a, b, c provide communication paths to the storage controller 8. The storage controller 8 issues command to physically position the electromechanical devices to read the DASD 6.

The storage controller 8 further includes a cache 12. In alternative embodiments, the cache 12 may be implemented in other storage areas accessible to the storage controller 8. In preferred embodiments, the cache 12 is implemented in a high speed, volatile storage area within the storage controller 8, such as a DRAM, RAM etc. The length of time since the last use of a record in cache 12 is maintained to determine the frequency of use of the cache. Data can be transferred between the channels 10a, b, c and the cache 12, between the channels 10,a, b, c and the DASD 6, and between the DASD 6 and the cache 12.

Also included in the storage controller 8 is a non-volatile storage (NVS) unit 14, which in preferred embodiments is a battery backed-up RAM, that stores a copy of modified data maintained in the cache 12. In this way, if failure occurs and the modified data in cache 12 is lost, then the modified data may be recovered from the NVS unit 14.

FIG. 2 shows storage controller 8 in more detail. Storage controller 8 includes two storage clusters 32 and 34, each of which provides for selective connection between a host computer and a logical DASD. Both storage clusters 32 and 34 are coupled to some or all of the host computers through the host channels, and, thus, every host computer system has access to any of the logical DASDs for storage and retrieval of data. Storage controller 8 may receive a request from a host computer over one host channel and respond to the request over the same or any other one of the host channels connected to the same host computer.

The four data paths 30, 36, 38 and 40 couple storage controller 8 to the DASD 8. Each data path 30, 36-40 is associated with a single dedicated storage path processor 42-48, respectively. Each data path 30, 36-40 is coupled to all logical storage elements of the DASD 8 but only one such data path has access to a particular logical store at any instant.

In addition to storage clusters 32 and 34, storage controller 8 includes a controller cache memory (CCM) 50 and a nonvolative store 52. CCM 50 provides storage for frequently accessed data and buffering to provide balanced response times for cache writes and cache reads. Nonvolatile store 52 provides temporary storage of data being written to CCM 50 until destaged to permanent storage in DASD 8.

Storage clusters 32 and 34 provide identical functional features, which are now described in connection with storage cluster 32 alone. Storage cluster 32 includes a multipath storage director 54 that operates as a four or eight by two switch between the host channels and signal path processors 46-48. Storage cluster 32 also includes a shared control array 56 that duplicates the contents of the shared control array 58 in storage cluster 34. Shared control arrays 56-58 store path group information and control blocks for the logical DASDs and may also include some of the data structures used to control CCM 50.

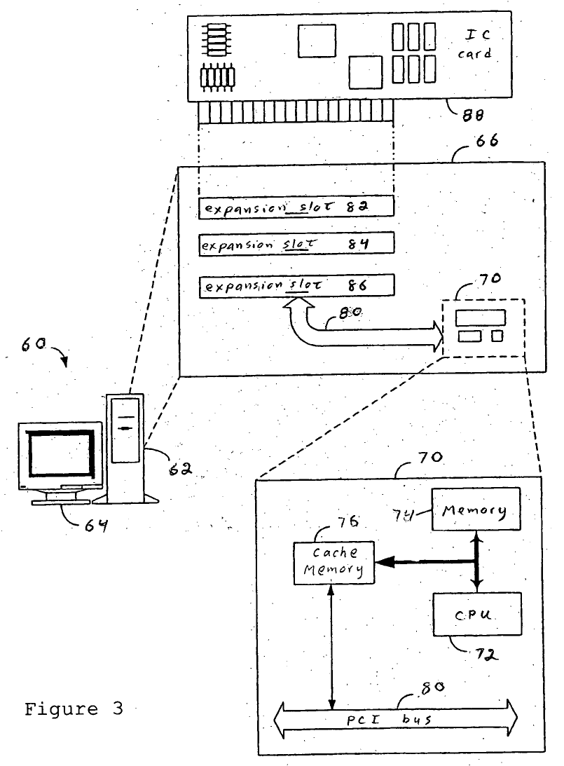

FIG. 3 shows, as an example, one host computer that may be used in the environment of FIG. 1. In this regard, the computer system 60 may be any of a variety of computing systems, such as a high-end desktop computing system having a computer 62 and monitor 64. Although the computer 62 may come in a variety of forms, a typical computer 62 will include a motherboard 66. As is known, the motherboard 66 typically includes various on-board integrated circuit components 70. These on-board integrated circuit components 70 may include devices like a CPU 72 (e.g., a microprocessor), a memory 74, and a variety of other integrated circuit devices known and included in computer architectures.

Another integrated circuit device, whether located on the motherboard or located on a plug-in card, is a cache memory 76. The cache memory 76 is disposed in communication with a PCI bus 80. A variety of other circuit components may be included within the computer system 60 as well. Indeed, a variety of other support circuits and additional functional circuitry are typically included in most high-performance computing systems. The addition and implementation of other such circuit components will be readily understood by persons of ordinary skill in the art, and need not be described herein. Instead, the computing system 60 has been shown with only a select few components in order to better illustrate the concepts and teachings of the present invention.

As is further known, in addition to various onboard circuit components, computing systems usually include expansive capability. In this regard, most computing systems 60 include a plurality of expansion slots 82, 84, 86, which allow integrated circuit cards 88 to be plugged into the motherboard 66 of computing system 60.

The above-describes environment thus has a multiple cache hierarchy, comprised of the storage controller cache and the host computers' caches 74 and 76. In particular, the host's CPU cache 76 adds yet another level to the hierarchical caching environment (i.e. disk 6, controller cache 12 or 50, host disk cache (in memory 74), CPU cache 76, CPU 72). The CPU cache is faster to access than memory, but is more expensive per byte, and therefore has less capacity than memory. This multiple cache hierarchy presents novel challenges and opportunities, and in particular, this can result in the same data being cached in both the controller and a host computer, resulting in a waste of cache space.

The present invention addresses this challenge. Generally, this is done by making the controller's cache an extension of the host's cache, rather than a duplication. To achieve this, the controller needs to know:
1. what data, being requested by the host, is being cached by the host, and should not be cached by the controller, and
2. what data has been cast out of the host's cache, and should now be cached by the controller.

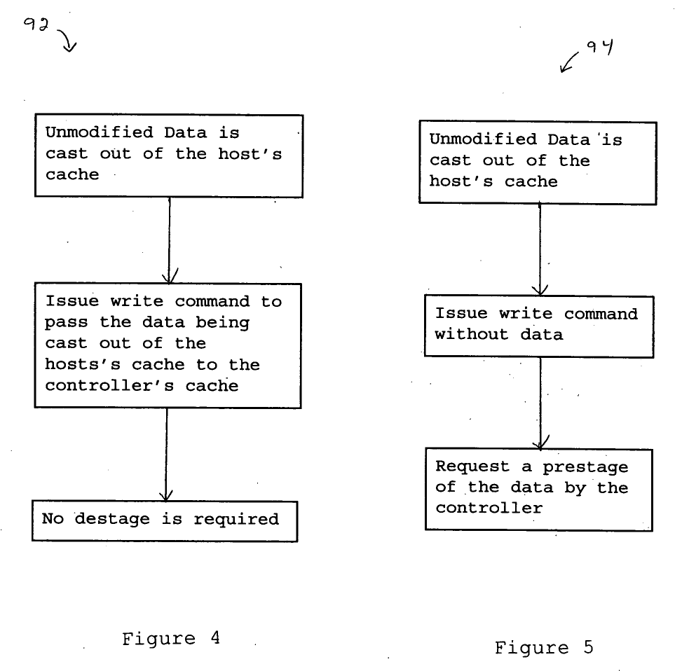

More specifically, with reference to FIG. 4, the invention preferably provides a new write command, represented at 92, (from host to controller) which is issued when unmodified data is cast out of the host's cache. This command would pass the data which has been cast out of the host's cache to the controller's cache without requiring a disk operation. A new command is required, in order to signal the controller that the data being written matches the data on disk and no destage is required when the data is cast out of the controller's cache. As represented in FIG. 5 at 94, the command (without the data transfer) could optionally be used to request a prestage of the data by the controller.

In addition, an analogous new write (from CPU cache to memory) can be implemented to move unmodified data from the CPU cache to memory, where the memory retains an “unmodified” state.

The advantage is lower in this case since the CPU cache is typically much smaller than memory. The controller cache is also typically much smaller than disk. However, the host disk cache and the controller cache are typically similar in size, therefore, using the controller cache as extensions to the host disk cache (eliminating the duplicates) can nearly double the effective composite size.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention

1. A method of managing data in a hierarchical caching environment, having a first cache at a first level of a hierarchy and a second cache at a second level of the hierarchy, the method comprising the steps:
removing data from the first cache; and
transmitting a command to the second level of the hierarchy, said command identifying the removed data and signaling that the data does not need to be destaged from the second level of the hierarchy to a third level of the hierarchy.

2. A method according to claim 1, wherein the command signals that the removed data matches data in the third level of the hierarchy.

3. A method according to claim 1, wherein the command includes the removed data.

4. A hierarchical data caching system, comprising:
a first cache at a first hierarchical level;
a second cache at a second hierarchical level; and
means for removing data from the first cache, and for transmitting a command to the second level of the hierarchy, said command identifying the removed data and signaling that the data does not need to be destaged from the second level of the hierarchy to a third level of the hierarchy.

5. A system according to claim 4, wherein the command signals that the removed data matches data in the third level of the hierarchy.

6. A system according to claim 4, wherein the command includes the removed data.

7. A method of managing data in a multi computer environment including multiple host computer systems, a direct access storage device system, and a storage controller for interfacing between the host computer systems and the direct access storage device system, the storage controller including a controller cache, and each of the host computer systems including a host cache, the method comprising:
removing data from the cache of one of the host computer systems; and
said one of the host computer systems transmitting a command to the controller, said command identifying the removed data, and signaling that the controller does not need to destage the data to the storage devices system.

8. A method according to claim 7, including the further step of the controller writing the data into the controller cache.

9. A method according to claim 7, wherein the command signals that the data matches data in the storage devices system.

10. A method according to claim 7, wherein the command includes the removed data.

11. A method according to claim 7, wherein the transmitting step includes the step of said one of the hosts transmitting the command to the controller when the data is removed from the cache of said one of the hosts.

12. A data management system for managing data in a multi computer environment including multiple host computer systems, a direct access storage devices system, and a storage controller for interfacing between the host computer systems and the direct access storage devices system, the storage controller including a controller cache, and each of the host computer systems including a host cache, the data management system comprising:
means for removing data from the cache of one of the host computer systems; and
means for transmitting a command to the controller, said command identifying the removed data, and signaling that the controller does not need to destage the data to the storage devices system.

13. A data management system according to claim 12, wherein the command signals that the data matches data in the storage devices system.

14. A data management system according to claim 12, wherein the command includes the removed data.

15. A data management system according to claim 12, wherein the means for transmitting includes means for transmitting the command to the controller in response to the data being removed from the cache of said one of the hosts.

16. A program storage device readable by machine, tangibly embodying a program of instructions executable by the machine to perform method steps for managing data in a multi computer environment including multiple host computer systems, a direct access storage device system, and a storage controller for interfacing between the host computer systems and the direct access storage device system, the storage controller including a controller cache, and each of the host computer systems including a host cache, the method steps comprising:
removing data from the cache of one of the host computer systems; and
said one of the host computer systems transmitting a command to the controller, said command identifying the removed data, and signaling that the controller does not need to destage the data to the storage devices system.

17. A program storage device according to claim 16, wherein said method steps include the further step of the controller writing the data into the controller cache.

18. A program storage device according to claim 16, wherein the command signals that the data matches data in the storage devices system.

19. A program storage device according to claim 16, wherein the command includes the removed data.

20. A method of managing data in a multi computer environment including multiple host computer systems, a direct access storage device system, and a storage controller for interfacing between the host computer systems and the direct access storage device system, the storage controller including a controller cache, and each of the host computer systems including a host cache, the method comprising:
removing data from the cache of one of the host computer systems; and
said one of the host computer systems transmitting a command to the controller, said command identifying the removed data, and requesting a pre stage of the data by the controller.

21. A method according to claim 20, wherein the transmitting step includes the step of said one of the host computer systems transmitting the command to the controller when the data is removed from the cache of said one of the host computer systems.

22. A data management system for managing data in a multi computer environment including multiple host computer systems, a direct access storage device system, and a storage controller for interfacing between the host computer systems and the direct access storage device system, the storage controller including a controller cache, and each of the host computer systems including a host cache, the data management system comprising:
means for removing data from the cache of one of the host computer systems; and
means for transmitting a command to the controller, said command identifying the removed data, and requesting a pre stage of the data by the controller.

23. A data management system according to claim 22, wherein the transmitting means includes means for transmitting the command to the controller when the data is removed from the cache of said one of the host computer systems.

24. A data management system according to claim 22, wherein the transmitting means includes means for transmitting the command to the controller in response to the data being removed from the cache of said one of the host computer systems.

25. A method for managing data in a data storage environment with multiple devices sharing data in a storage hierarchy, the method comprising:
writing data from a first of the devices to a second of the devices; and
indicating that the data need not be destaged by the second of the devices to a lower tier of the storage hierarchy.

26. A method according to claim 25, further comprising the step of removing the data from the first of the devices, and wherein the indicating step includes the step of indicating to the second of the devices, when the data is removed from the first of the devices, that the data need not be destaged to said lower tier.

27. A method according to claim 25, further comprising the step of removing the data from the first of the devices, and wherein the indicating step includes the step of indicating to the second of the devices, in response to the data being removed from the first of the devices, that the data need not be destaged to said lower tier.

28. A data management system for managing data in a data storage environment with multiple devices sharing data in a storage hierarchy, the data management system comprising:
means for writing data from a first of the devices to a second of the devices; and
means for indicating that the data need not be destaged by the second of the devices to a lower tier of the storage hierarchy.

29. A data management system according to claim 28, further comprising means for removing the data from the first of the devices, and wherein the means for indicating includes means for indicating to the second of the devices, when the data is removed from the first of the devices, that the data need not be destaged to said lower tier.
